(19) United States
(12) Patent Application Publication
(10) Pub. No.: US 2018/0165753 A1
(43) Pub. Date: Jun. 14, 2018

(54) INTELLIGENT ORDER ROUTING

(71) Applicant: ORACLE INTERNATIONAL CORPORATION, Redwood Shores, CA (US)

(72) Inventors: Michael S. CARTER, Georgetown, KY (US); Jessica M. BENOIT, Wilder, VT (US); Steven H. SINGER, Marlborough, MA (US); Richard A. CHURCHILL, Toronto (CA)

(21) Appl. No.: 15/372,755

(22) Filed: Dec. 8, 2016

(51) Int. Cl. G06Q 30/06; G06F 17/30

(52) U.S. Cl. CPC G06Q 30/0635; G06F 17/30867; G06F 17/30663

(57) ABSTRACT

Systems, methods, and other embodiments associated with intelligent order routing are described. In one embodiment, a method includes receiving and parsing an electronic order. The example method may also include identifying a set of sourcing locations capable of sourcing an item for the electronic order. The example method may also include applying a set of weighted criteria to each sourcing location. The example method may also include generating ranks for each sourcing location. The example method may also include generating a set of control instructions within a data structure that identifies an item of the electronic order and a target sourcing location from the set of sourcing locations having a target rank exceeding a threshold. The example method may also include sending the data structure to a remote computer to cause the remote computer to initiate a transfer of the item from the target sourcing location to an item destination.

### BACKGROUND

Many retailers and other entities allow customers to order items that are not immediately available at a store. The customers can also order items through websites or other online services provided by such entities. For example, a customer may walk into a clothing store looking to purchase a white shirt and black tie. If the clothing store does not have in-stock availability of the white shirt and the black tie to sell to the customer, then the clothing store creates an electronic order for the customer. The electronic order is a request for the white shirt and the black tie to be sourced from a sourcing location (e.g., a different store, a warehouse, etc.) to an item destination a home of the customer or a nearby store.

Order fulfillment functionality by a computing system will pick a default sourcing location, an arbitrary sourcing location, or a closest sourcing location to the item destination for processing the white shirt and the black tie to the item destination. Unfortunately, picking the default sourcing location, the arbitrary sourcing location, or the closest sourcing location is imprecise and leads to inefficiencies because other factors can affect the decision. For example, the closest sourcing location could have a higher cost to process and ship the black tie to the item destination than a cost of a different sourcing location that is further away from the item destination.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a system associated with intelligent order routing.

FIG. 2 illustrates one embodiment of a method associated with intelligent order routing.

FIG. 3 illustrates one embodiment of filtering criteria.

FIG. 4 illustrates one embodiment of a set of weighted criteria.

FIG. 5 illustrates one embodiment of a non-transitory computer-readable medium.

FIG. 6 illustrates one embodiment of a computing system configured with the example systems and/or methods disclosed.

### DETAILED DESCRIPTION

Computerized systems and methods are described herein that provide for intelligent order routing for controlling computerized inventory systems to ship products. Many retailers are omni-channel retailers that allow customers to buy products from anywhere and the retailers can fulfill orders from anywhere. For example, a customer walks into an electronics store seeking a tablet. If the electronics store does not have the tablet in stock, then an inventory management module is used to identify a sourcing location from which the tablet is available. The sourcing location could be a warehouse or another store that can ship the tablet to the electronics store or to a home of the customer. The sourcing location could be a nearby store at which the tablet can be picked up by the customer. When identifying the sourcing location, either an employee must manually select a particular sourcing location or the inventory management module automatically selects a suggested sourcing location. Manually selecting the sourcing location is imprecise and leads to inefficiencies due to a lack of knowledge about sourcing from different sourcing locations and human error. For example, if the employee selects a sourcing location in Toronto to source to the electronics store in San Francisco (e.g., because the Toronto store is a closest store), then various costs, business implications, and/or tax implications can arise. But the employee is not aware of these other factors because the decision was simply based on physical proximity or default settings.

The suggested sourcing location would have been selected based upon either a predefined default sourcing location for the electronics store, an arbitrarily selected sourcing location, or a closest sourcing location. Selecting such sourcing locations without further considerations leads to inefficiencies and additional costs. For example, the closest sourcing location is undesirable if labor costs are high to ship the item, profit margin is higher if the item is sold at the closest sourcing location, an on-hand quantity is low, and a sales velocity indicates that the tablet will be sold quickly at a lower cost and higher profit than by shipping the tablet to the electronics store. Thus, profitability of sourcing the tablet from sourcing locations is not taken into account.

Accordingly, in one embodiment, a computerized system is described that is configured to rank sourcing locations based upon weighted cost values assigned to the sourcing locations by a set of weighted criteria. In this way, sourcing locations are ranked based upon various weighted criteria that are indicative of profit of sourcing items from each sourcing location for fulfilling an electronic order. Thus, a sourcing location that will result in a desirable profit (e.g., a highest profit) is identified and used to source an item for fulfilling the electronic order. The present system improves the inventory control process as compared to prior systems that simply select a source location based on assigned default values or based on a manual selection of a source location.

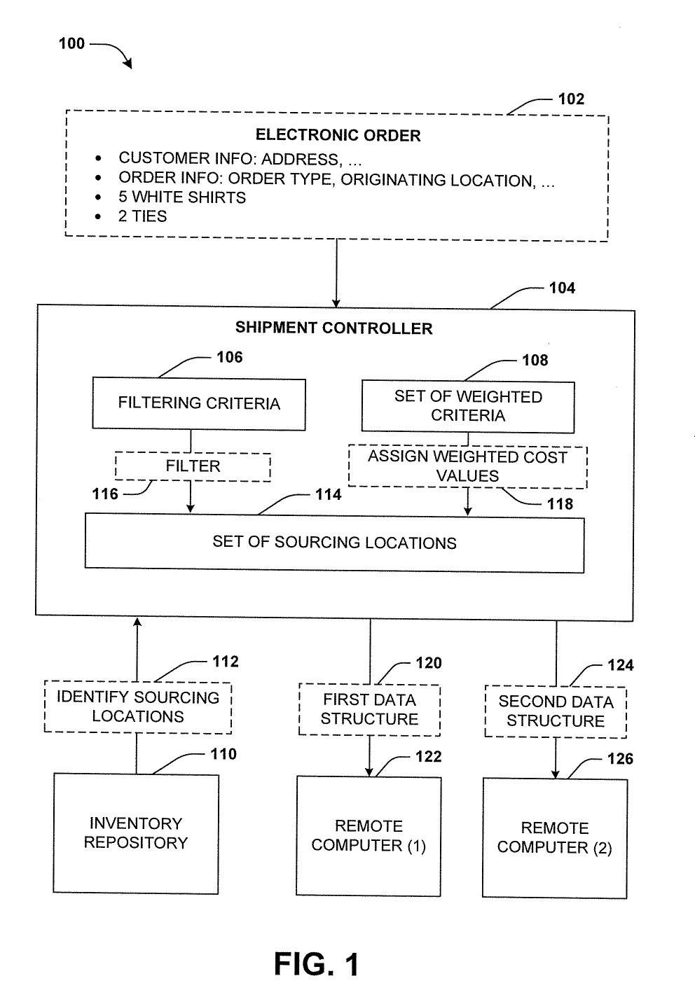

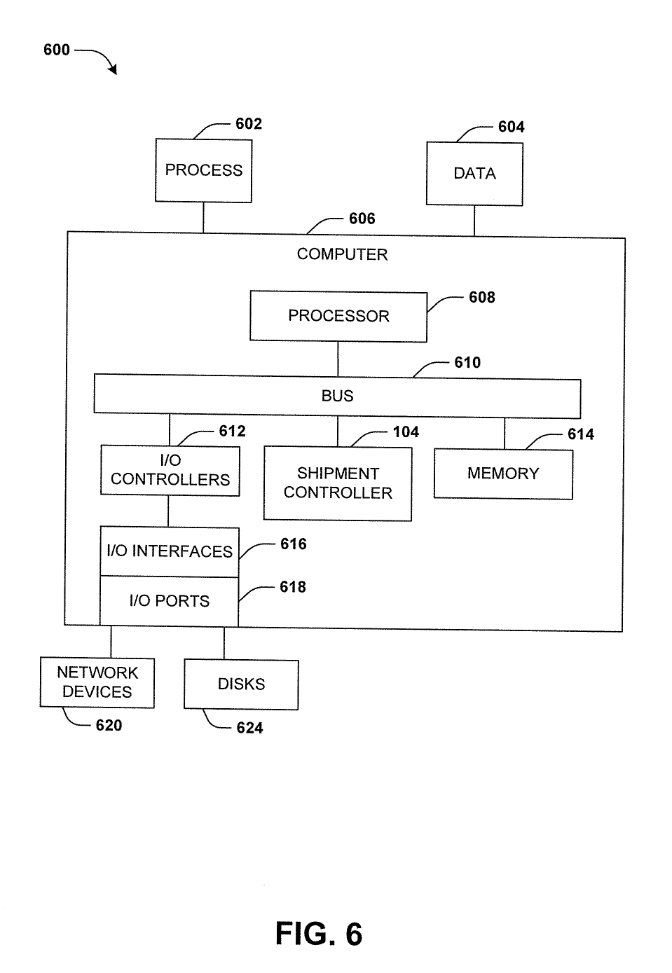

With reference to FIG. 1, one embodiment of a computer system 100 associated with intelligent order routing is illustrated. The system 100 includes a shipment controller 104 for intelligent order routing, which can be configured to execute on a computer, such as computer 606 of FIG. 6. An electronic order 102 is received and parsed to identify an item (e.g., white shirts and ties) and an item destination such as a store or a customer's home. A set of sourcing locations 114 capable of sourcing the item to the destination may be identified. In an example, an inventory repository 110, such as a database, system, or other information source, is queried to identify the set of sourcing locations 114. In another example, the set of sourcing locations 114 may have been predetermined and provided to the system 100.

Various criteria are used to filter the set of sourcing locations. For example, if a sourcing location has already reached an order limit of orders allowed to be fulfilled by the sourcing location (e.g., a store is only allowed to fulfill 10 orders a day), then the sourcing location is removed from the set of sourcing locations. In another example, if the sourcing location does not have more than a reserve stock amount of hats (e.g., the store is to keep at least 3 hats), then the sourcing location is removed. In this way, various filtering criteria are used to filter/remove sourcing locations that are not desirable to use for sourcing the item.

A set of weighted criteria 108 are used to assign weighted cost values to sourcing locations based upon costs associated with processing the item from sourcing locations to the item destination. The set of weighted criteria 108 assign weighted brokering values such as weighted cost values to a sourcing location based upon various criteria, such as labor, proximity, gross margin, sales velocity (e.g., turnover), and/or on hand values (e.g., Available to Promise (ATP) values). The weighted brokering values are used to weight shopping logic used to identify a most profitable sourcing location. The set of weighted criteria 108 may assign weighted cost values based upon a labor cost to process the item from the sourcing location. It may be appreciated that as used herein, a weighted cost value may refer to a weighted brokering value used to weight logic that identifies a target sourcing location, such as a most profitable sourcing location for an item. The set of weighted criteria 108 may assign weighted cost values based upon a gross margin for selling the item through the sourcing location (e.g., the gross margin may be based upon a selling price of the item, which may be variable based upon whether the item is currently being sold or designated to be sold at an original retail price, at a clearance price, on special such as a buy one get one free special, etc.). The set of weighted criteria 108 may assign weighted cost values based upon a proximity of the sourcing location to the item destination. The set of weighted criteria 108 may assign weighted cost values based upon an on-hand quantity of the item at the sourcing location. The set of weighted criteria 108 may assign weighted cost values based upon a sales velocity of how quickly the item is sold by the sourcing location.

The sourcing locations are ranked based upon the weighted cost values assigned to the sourcing locations. For example, weighted cost values assigned to a sourcing location are combined, such as summed, to create a rank for the sourcing location. In this way, a target sourcing location is selected based upon the target sourcing location having a desired rank such as a highest rank. The target sourcing location is selected with improved precision because additional considerations and preferences are taken into account by the various types of weighted criteria. In this way, an efficient and cost effective target sourcing location is identified and selected for sourcing the item to the item destination. For example, the target sourcing location is more profitable than other sourcing locations, such as more profitable than a closer sourcing location to the item destination that otherwise has a higher cost for sourcing the item.

In one embodiment, the target sourcing location is identified in real-time using linear programming in order to reduce complexity and improve performance. The identification of the target sourcing location can use more variables, such as the weighted criteria, in the analysis that would otherwise multiply the complexity of identifying the target sourcing location. In this way, processing resources, memory, and/or other resources are conserved, such as where there are hundreds or thousands of candidate sourcing locations and/or combinations of sourcing locations for multi-item orders.

In one embodiment of intelligent order routing, the shipment controller 104 is initiated based upon receipt of the electronic order 102. For example, the electronic order 102 is received over a network from a remote computer associated with a San Francisco store through which a customer wants to order 5 white shirts and 2 ties. The electronic order 102 includes customer information of the customer such as an address of the customer, order information such as an order type and originating location of the electronic order 102 (e.g., the San Francisco store), a first line item requesting 5 white shirts, and a second line item requesting 2 tics. The order type can be a delivery order type where the items are to be delivered to the customer's home. The order type can be a pickup order type where the customer will pick the items up at a store having the items in stock. The order type can be a ship for pickup order type where the items are shipped to the San Francisco store or to another store. It may be appreciated that a variety of order types may be supported, such as a retail pickup order type.

The shipment controller 104 queries the inventory repository 110 using identifiers for white shirts and ties as selection parameters in order to identify 112 the set of sourcing locations 114 that have white shirts and/or ties in stock. The set of sourcing locations 114 can include warehouses, other stores, etc. In one embodiment, requests are sent by the shipment controller 104 to remote devices associated with sourcing locations in order to obtain real-time inventory information. For example, an electronic request is sent over a network to a computer associated with a Toledo store. The electronic request includes instructions for the computer to determine real-time inventory information for the white shirts and/or ties. In this way, the shipment controller 104 will receive real-time inventory information used to identify the set of sourcing locations 114 that have white shirts and/or ties.

Filtering criteria 106 are used to filter 116 the set of sourcing locations 114. In one embodiment of the filtering 116, the set of sourcing locations 114 are filtered to remove sourcing locations that are beyond a threshold distance of a location of the customer. For example, the customer may specify that the customer wants to pick the item up from the sourcing location, and thus the sourcing location is the item destination. The customer or a predefined setting by a retailer specifies the threshold distance as 25 miles (e.g., a 25 mile radius from the address of the customer) or any other distance, and thus sourcing locations beyond the 25 mile radius of the customer's home are removed from the set of sourcing locations 114.

In another embodiment of the filtering 116, the set of sourcing locations 114 are filtered 116 based upon a reserve stock criteria. The reserve stock criteria filters sourcing locations with amounts of the item that do not exceed a reserve stock threshold. For example, stores may be instructed to keep at least 2 white shirts in stock (e.g., for display purposes). Thus, if a sourcing location has 2 white shirts or less, then the sourcing location is removed from the set of sourcing locations 114.

In another embodiment of the filtering 116, the set of sourcing locations 114 are filtered 116 based upon an origination location criteria. The origination location criteria specifies that if a sourcing location is an originating location of the electronic order 12, then the sourcing location is to be removed from the set of sourcing locations 114. For example, if the customer is creating the electronic order 102 at the San Francisco store as the originating location, then the San Francisco store most likely does not have the items in stock. In an example, the origination location criteria is used to filter the originating location for delivery order types and retail pickup order types. The origination location criteria does not filter the originating location for a ship for pickup order type unless the originating location is the same as an assigned pickup location for the electronic order 102.

In another embodiment of the filtering 116, the set of sourcing locations 114 are filtered 116 based upon whether sourcing locations support the order type of the electronic order 102. For example, a kiosk in the middle of a mall might not support a delivery order type because the kiosk is not setup for shipping out inventory.

In another embodiment of the filtering 116, the set of sourcing locations 114 are filtered 116 based upon an order limit criteria. The order limit criteria limits a number of orders that sourcing locations are allowed to fulfill within a timespan. For example, stores may be limited to fulfilling 25 orders within a day. In this way, stores that have fulfilled 25 orders for a day are removed from the set of sourcing locations 114.

In another embodiment of the filtering 116, the set of sourcing locations 114 are filtered 116 based upon primary sourcing location and secondary sourcing location designations. For example, a retailer specifies a primary zone for a location of the item destination (e.g., an east coast zone, a zone encompassing a state, a zone within a 100 mile radius, or any other designation of a region of sourcing locations). Sourcing locations within the primary zone are designated as primary sourcing locations. Other sourcing locations are designated as secondary sourcing locations. Primary sourcing locations are preferred over secondary sourcing locations. Accordingly, primary sourcing locations are identified 112 as the set of sourcing locations 114 if there are any. However, if primary sourcing locations are not available for satisfying the electronic order 102, then secondary sourcing locations are considered.

In another embodiment of the filtering 116, the set of sourcing locations 114 are filtered 116 based upon whether a split order setting is enabled or disabled. For example, the retailer prefers to fulfill the electronic order 102 from a single sourcing location if possible. However, there are instances where there is no single sourcing location capable of fulfilling the electronic order 102 (e.g., no sourcing location has 5 white shirts and 2 ties). Accordingly, if the split order setting is enabled, then sourcing locations capable of satisfying the first line item of 5 white shirts and sourcing locations capable of satisfying the second line item of 2 ties are identified 112 as the set of sourcing locations 114.

In another embodiment of the filtering 116, the set of sourcing locations 114 are filtered 116 based upon whether a split line setting is enabled or disabled. For example, the retailer prefers to fulfill the entire electronic order 102 or entire line items from single sourcing locations. However, there are instances where there is no single sourcing location capable of fulfilling the electronic order 102 or entire line items. Accordingly, if the split line setting is enabled, then sourcing locations capable of satisfying individual items are identified 112 as the set of sourcing locations 114. For example, a sourcing location is identified if the sourcing location has a least one white shirt or at least one tie available.

In an example, if the electronic order is split more than a threshold number of times, then the electronic order may be marked as unfulfillable. For example, the threshold may be set as a maximum number of allowed splits for the electronic order (e.g., fulfillment of items of the electronic order may be split between no more than 3 sourcing locations, otherwise, the electronic order may be marked as unfulfillable).

In another embodiment of the filtering 116, the set of sourcing locations 114 are filtered 116 based upon whether a backorder setting is enabled or disabled. For example, if no sourcing locations are capable of satisfying the electronic order 102 with in-stock inventory and the backorder setting is enabled, then sourcing locations are identified 112 that have the item on backorder. In an example, the sourcing locations having the item on backorder may be considered only after primary sourcing locations, secondary sourcing locations, and/or combinations thereof identified by the split order setting and/or the split line setting, when enabled, are considered.

In this way, the filtering criteria 106 are used to filter 116 the set of sourcing locations 114.

The set of weighted criteria 108 are applied by the shipment controller 104 to the set of sourcing locations 114 in order to rank each sourcing locations. The sourcing locations are ranked in order to identify a target sourcing location with a desired profitability (e.g., a highest profitability) for sourcing items to satisfy the electronic order 102.

The set of weighted criteria 108 assign 118 weighted cost values representing costs associated with processing white shirts and/or ties from sourcing locations to the item destination. In one embodiment, the set of weighted criteria 108 are weighted with percentages representing how important each weighted criteria are to the retailor and/or how much they affect profitability (e.g., the retailer assigns a 40% weight to a first weighted criteria and a 10% weight to a second weighted criteria because the first weighted criteria is more important to the retailer than the second weighted criteria). In one embodiment, the percentages total 100%. It is appreciated that the weights can be numerical, percentages, or any other weighted value.

A cost corresponds to various costs associated with processing an item to the item destination for fulfilling the electronic order 102, such as a labor cost to ship the item. Gross margin is another cost that corresponds to an in-store selling price minus an in-store cost to sell the item. Proximity of a sourcing location to the item destination is another cost. An on-hand quality of the item is another cost. A sales velocity of how quickly the item is sold by a sourcing location is yet another cost.

In one embodiment of assigning 118 weighted cost values, a first weighted cost value is assigned to a sourcing location based upon a first weighted criteria corresponding to a labor cost to process the item from the sourcing location. Sourcing locations with lower labor costs are weighted higher (e.g., are preferred) because lower labor costs result in higher profitability.

In another embodiment of assigning 118 weighted cost values, a second weighted cost value is assigned to the sourcing location based upon a second weighted criteria corresponding to a gross margin for selling the item through the sourcing location. The gross margin corresponds to a selling price of the item at the sourcing location minus a cost to sell the item through the sourcing location. Sourcing locations with smaller gross margins are weighted higher (e.g., are preferred for sourcing the item from the sourcing location to the item destination) because keeping and selling items at sourcing locations with higher gross margins results in higher profitability.

In another embodiment of assigning 118 weighted cost values, a third weighted cost value is assigned to the sourcing location based upon a third weighted criteria corresponding to a proximity of the sourcing location to the item destination. Sourcing locations that are closer to the item destination are weighted higher (e.g., are preferred) because shipping from closer sourcing locations is cheaper and thus results in higher profitability.

In another embodiment of assigning 118 weighted cost values, a fourth weighted cost value is assigned to the sourcing location based upon a fourth weighted criteria corresponding to an on-hand quantity of the item at the sourcing location. Sourcing locations that having greater on-hand quantities of the item are weighted higher (e.g., are preferred) because it is more desirable to source from sourcing locations that have greater amounts of the item.

In another embodiment of assigning 118 weighted cost values, a fifth weighted cost value is assigned to the sourcing location based upon a fifth weighted criteria corresponding to sales velocity of how quickly the item is sold by the sourcing location. A retailer can specify whether a smaller sales velocity or a larger sales velocity is preferred. For example, sourcing locations that have slow sales velocity for selling the item are weighted higher (e.g., are preferred) because such sourcing locations are less likely to sell the item than sourcing locations with higher sales velocity.

The shipment controller 104 generates ranks for each sourcing location of the set of sourcing locations 114 based on a combination of weighted cost values assigned to sourcing locations. For example, the weighted cost values assigned to a first sourcing location by the set of weighted criteria 108 are summed to create a rank for the first sourcing location. In one embodiment, a net profit metric is used for creating the rank and/or assigning 118 the weighted cost values. The net profit metric is based upon the first weighted cost value of the labor cost and the second weighted cost value of the gross margin.

One or more target sourcing locations for sourcing items to the item destination are identified based upon their ranks. For example, a first sourcing location, having a highest rank for sourcing the 5 white shirts, is identified. A second sourcing location, having a highest rank for sourcing the 2 ties, is identified. First control instructions are generated within a first data structure 120. The first control instructions identify the 5 white shirts and the first sourcing location. Second control instructions are generated within a second data structure 124. The second control instructions identify the 2 ties and the second sourcing location.

The shipment controller 104 sends (e.g., transmits over a network) the first data structure 120 to a first remote computer 122 associated with the first sourcing location, for executing the first set of control instructions to cause the first remote computer 122 to initiate a transfer of the 5 white shirts from the first sourcing location to the item destination. The shipment controller 104 sends (e.g., transmits over a network) the second data structure 124 to a second remote computer 126 associated with the second sourcing location, for executing the second set of control instructions to cause the second remote computer 126 to initiate a transfer of the 2 ties from the second sourcing location to the item destination. In this way, the electronic order 102 is fulfilled in an efficient manner that increases profitability.

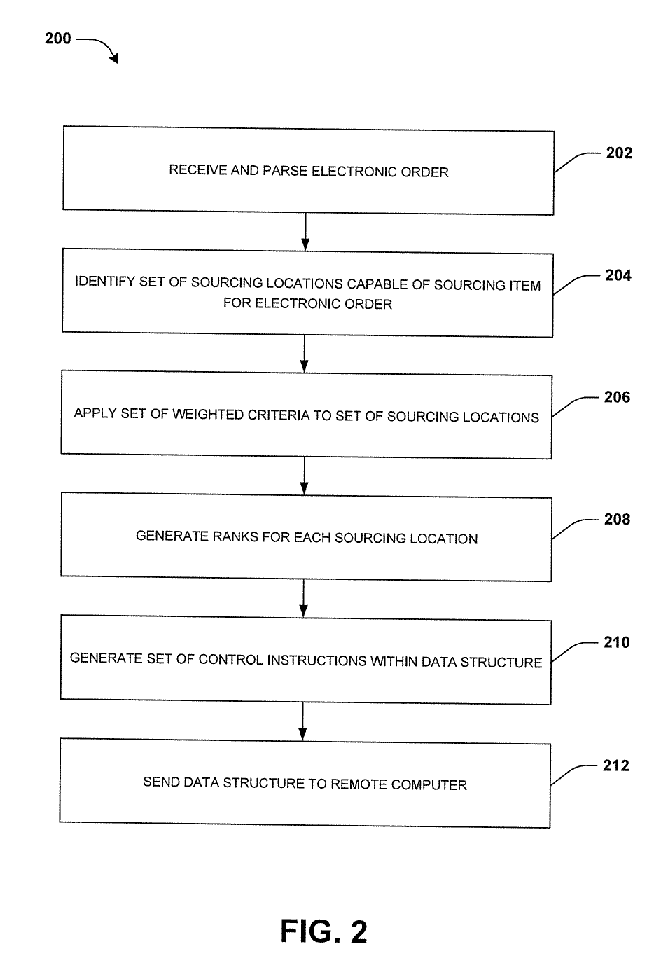

With reference to FIG. 2, one embodiment of a computer implemented method 200 associated with intelligent order routing is illustrated. In one embodiment, the method 200 is performed by the shipment controller 104 utilizing various computing resources of the computer 606, such as the processor 608 for executing instructions associated with filtering 116 sourcing locations, assigning 118 weighted cost values to souring locations, and/or ranking sourcing locations. Memory 614 and/or disks 624 are used for storing the set of sourcing locations 114, the filtering criteria 106, and/or the set of weighted criteria 108. Network hardware is used for communicating data structures between the computer 606 and remote computers over a network. The method 200 is triggered upon receipt of the electronic order 102, such as by the computer 606.

At 202, the electronic order 102 is received and parsed to identify item(s) and an item destination. For example, the electronic order includes a requests for 2 brooms and 1 vacuum to be shipped to a Tampa store. At 204, the set of sourcing locations 114 that stock the brooms and/or vacuum are identified 112. In an example, the inventory repository 110, a database, a system, or any other informational source may be accessed or queried to identify the set of sourcing locations 114. In one embodiment, real-time inventory data is acquired from sourcing locations for identifying the set of sourcing locations 114 that stock the brooms and/or vacuum.

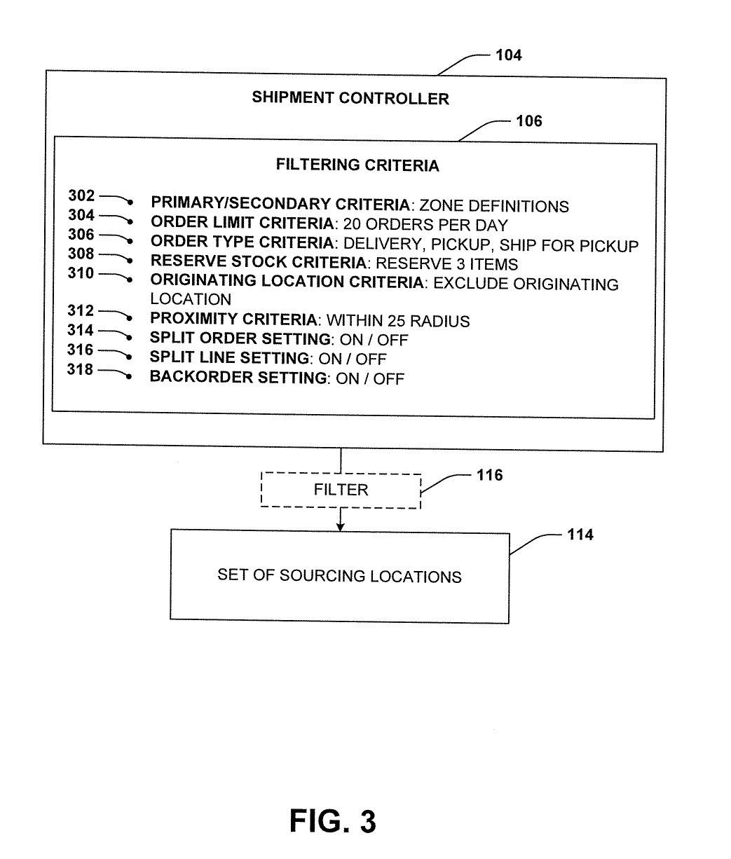

The set of sourcing locations 114 are filtered 116 based upon filtering criteria 106, as illustrated in FIG. 3. The filtering criteria 106 include a primary/second criteria 302 used to first identify and evaluate primary sourcing locations that have the brooms and/or vacuum, and then identify and evaluate secondary sourcing locations if there are no primary sourcing locations for sufficiently fulfilling the 2 brooms and 1 vacuum.

The filtering criteria 106 include an order limit criteria 304 used to filter out sourcing locations that have already fulfilled or are committed to fulfill 20 orders today. The filtering criteria 106 include an order type criteria 306 used to filter out sourcing locations that do not support an order type of the electronic order 102. The filtering criteria 106 include a reserve stock criteria 308 used to filter out sourcing locations that do not have at least a reserve stock threshold of an item such as at least 3 items. The filtering criteria 106 include an originating location criteria 310 used to filter out a sourcing location that is an originating location of the electronic order 102. The filtering criteria 106 include a proximity criteria 312 used to filter out sourcing locations that exceed a 25 mile radius from a location of a customer, such as where a sourcing location is used as the item destination for order pickup.

The filtering criteria 106 include a split order setting 314 used to first select sourcing locations that can fulfill the entire electronic order 102. If there is no single sourcing location that can fulfill the entire electronic order 102 and the split order setting is enabled, then sourcing locations that have at least 2 brooms and sourcing locations that have at least 1 vacuum are identified for inclusion within the set of sourcing locations 114. The filtering criteria 106 include a split line setting 316 used to select sourcing locations that have at least one broom if there are no sourcing locations that have at least 2 brooms. The filtering criteria 106 include a backorder setting 318 used to select sourcing locations have that brooms and/or vacuums on backorder based upon no single or combination of sourcing locations having enough in-stock items to fulfill the electronic order 102.

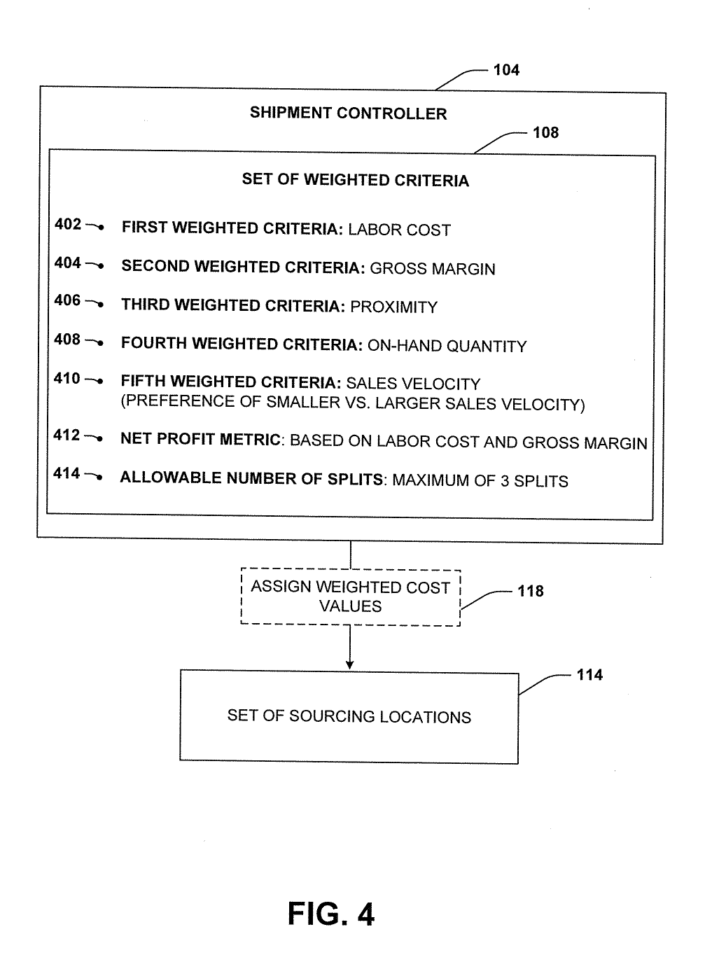

At 206, the set of weighted criteria 108 are assigned 118 to each sourcing location of the set of sourcing locations 114 (e.g., sourcing locations remaining after the filtering 116), as illustrated in FIG. 4. The set of weighted criteria 108 have weights that can be assigned by an owner of the sourcing locations such as a clothing retailer. In one embodiment, larger weights are assigned to more important criteria than less important criteria or vice versa. For example, the clothing retailer may care more about gross margin than proximity, and thus a second weighted criteria 404 associated with gross margin is weighted more than a third weighted criteria 406 associated with proximity.

In one embodiment, a first weighted criteria 402, corresponding to a labor cost to process order items to the item destination, is used to assign 118 weighted cost values to sourcing locations. Sourcing locations with higher labor costs are less desirable for sourcing ordered items, and are thus assigned 118 lower weighted cost values (e.g., or higher weighted cost values if higher values are indicative of less desirable sourcing locations).

In another embodiment, the second weighted criteria 404, corresponding to a gross margin (e.g., an in-store selling price of an item minus an in-store cost to sell an item), is used to assign 118 weighted cost values to sourcing locations. Sourcing locations with higher gross margins are less desirable for sourcing ordered items out of such sourcing locations, and are thus assigned 118 lower weighted cost values (e.g., or higher weighted cost values if higher values are indicative of less desirable sourcing locations).

In another embodiment, a net profit metric 412, based upon labor costs and gross margins, is use to assign 118 weighted cost values to sourcing locations and/or for ranking sourcing locations.

In another embodiment, the third weighted criteria 406, corresponding to a proximity of sourcing locations to the item destination, is used to assign 118 weighted cost values to sourcing locations. Sourcing locations that are further away from the item destination are less desirable for sourcing the item, and are thus assigned 118 lower weighted cost values (e.g., or higher weighted cost values if higher values are indicative of less desirable sourcing locations).

In another embodiment, a fourth weighted criteria 408, corresponding to an on-hand quantity of an item, is used to assign 118 weighted cost values to sourcing locations. Sourcing locations with less on-hand quantities of ordered items are less desirable for sourcing the ordered items, and are thus assigned 118 lower weighted cost values (e.g., or higher weighted cost values if higher values are indicative of less desirable sourcing locations). In an example, the fourth weighted criteria 408 is used to consider inventory Available to Promise (ATP). For example, the clothing retailer can apply a safety stock for an item, such as where on hand value of 5 minus a reserved stock of 2 produces an ATP of 3. The fourth weighted criteria 408 may take into consideration a safety stock of ATP minus 3, which would make the item not available.

In another embodiment, a fifth weighted criteria 410, corresponding to a sales velocity, is used to assign 118 weighted cost values to sourcing locations. The clothing retailer can specify whether a smaller sales velocity or a faster sales velocity is preferred for sourcing locations.

In this way, the set of weighted criteria 108 are used to assign 118 weighted cost values to sourcing locations. Sourcing locations with larger weighted cost values are more profitable for sourcing ordered item than sourcing locations with smaller weighted costs (e.g., or vice versa if higher values are indicative of less desirable sourcing locations).

At 208, ranks are generated for each sourcing location of the set of sourcing locations 114. A rank for a sourcing location is generated based upon a combination of a set of weighted cost values assigned to the sourcing location. For example, the rank is a sum of weighted cost values assigned by the first weighted criteria 402, the second weighted criteria 404, the third weighted criteria 406, the fourth weighted criteria 408, the fifth weighted criteria 410, and/or the net profile metric 412: Higher ranked sourcing locations are more profitable for sourcing ordered items than lower ranked sourcing locations.

In an example, an allowable number of splits metric 414 may be used to evaluate whether the electronic order 102 is fulfillable or unfulfillable. For example, the allowable number of splits metric 414 may indicate that the electronic order 102 is to be marked as unfulfillable if fulfillment of the electronic order 102 requires more than 3 splits between sourcing locations (e.g., more than 3 different sourcing locations are needed to adequately source items of the electronic order 102).

At 210, a set of control instructions are generated within a data structure that identify the ordered items (e.g., the 2 brooms and the vacuum) and a target sourcing location, of the set of sourcing locations 114, having a rank exceeding a threshold (e.g., a highest rank). At 212, the data structure is sent to a remote computer, associated with the target sourcing location, for executing the set of control instructions to cause the remote computer to initiate a transfer of the ordered items from the target sourcing location to the item destination. In an example, the data structure is sent in response to receiving an order assignment inquiry from the target sourcing location. For example, the target sourcing location may inquire as to which electronic orders the target sourcing location is assigned. Accordingly, the data structure may be provided to indicate that the target sourcing location is assigned to the electronic order for sourcing the item.

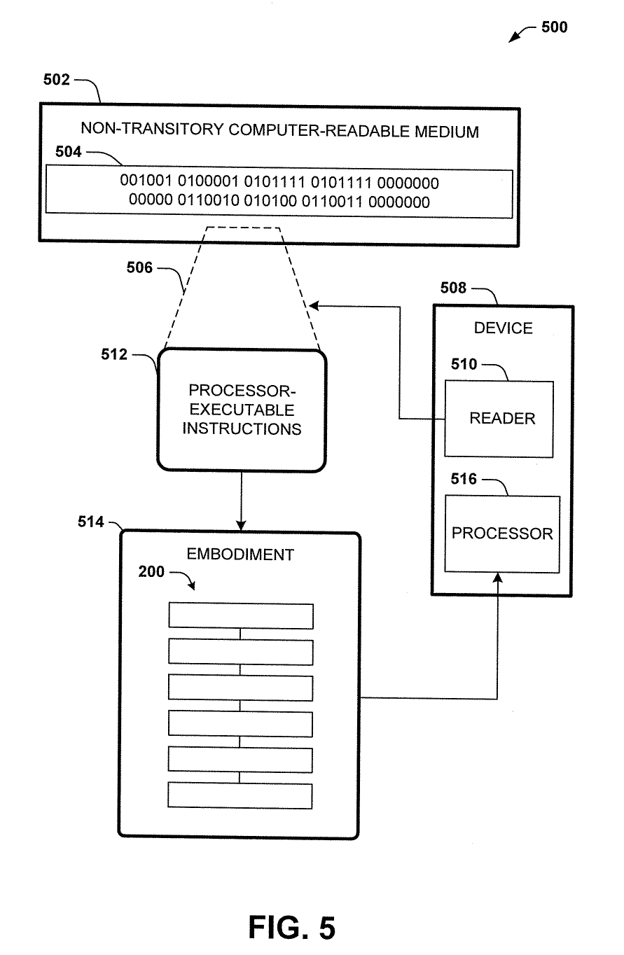

FIG. 5 is an illustration of a scenario 500 involving an example non-transitory computer-readable medium 502. In one embodiment, one or more of the components described herein are configured as program modules, such as the shipment controller 104, stored in the non-transitory computer-readable medium 502. The program modules are configured with stored instructions, such as processor-executable instructions 512, that when executed by at least a processor, such as processor 516, cause the computing device to perform the corresponding function(s) as described herein. For example, functionality of the shipment controller 104, stored in the non-transitory computer-readable medium 502, may be executed by the processor 516 as the processor-executable instructions 512 to perform an embodiment 514 of the method 200 of FIG. 2.

The non-transitory computer-readable medium 502 includes the processor-executable instructions 512 that when executed by a processor 516 cause performance of at least some of the provisions herein. The non-transitory computer-readable medium 502 includes a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory computer-readable medium 502 stores computer-readable data 504 that, when subjected to reading 506 by a reader 510 of a device 508 (e.g., a read head of a hard disk drive, or a read operation invoked on a solid-state storage device), express the processor-executable instructions 512.

In some embodiments, the processor-executable instructions 512, when executed cause performance of operations, such as at least some of the example method 200 of FIG. 2, for example. In some embodiments, the processor-executable instructions 512 are configured to cause implementation of a system, such as at least some of the example system 100 of FIG. 1, for example.

FIG. 6 illustrates an example computing device that is configured and/or programmed with one or more of the example systems and methods described herein, and/or equivalents. The example computing device may be the computer 606 that includes a processor 608, a memory 614, and I/O ports 618 operably connected by a bus 610. In one example, the computer 606 may include logic of the shipment controller 104 configured to facilitate the system 100 and/or the method 200 shown in FIGS. 1-2. In different examples, the logic of the shipment controller 104 may be implemented in hardware, a non-transitory computer-readable medium 702 with stored instructions, firmware, and/or combinations thereof. While the logic of the shipment controller 104 is illustrated as a hardware component attached to the bus 610, it is to be appreciated that in other embodiments, the logic of the shipment controller 104 could be implemented in the processor 608, stored in memory 614, or stored in disk 624.

In one embodiment, logic of the shipment controller 104 or the computer 606 is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application specific integrated circuit (ASIC) programmed to implement rule based source sequencing for allocation. The means may also be implemented as stored computer executable instructions that are presented to computer 606 as data 604 that are temporarily stored in memory 614 and then executed by processor 608.

The logic of the shipment controller 104 may also provide means (e.g., hardware, non-transitory computer-readable medium 702 that stores executable instructions, firmware) for performing rule based source sequencing for allocation.

Generally describing an example configuration of the computer 606, the processor 608 may be a variety of various processors including dual microprocessor and other multi-processor architectures. The memory 614 may include volatile memory and/or non-volatile memory. Non-volatile memory may include, for example, read-only memory (ROM), programmable read-only memory (PROM), and so on. Volatile memory may include, for example, random access memory (RAM), static random-access memory (SRAM), dynamic random access memory (DRAM), and so on.

The disks 624 may be operably connected to the computer 606 via, for example, the I/O interface 616 (e.g., card, device) and the I/O ports 618. The disks 624 may be, for example, a magnetic disk drive, a solid state disk drive, a floppy disk drive, a tape drive, a Zip drive, a flash memory card, a memory stick, and so on. Furthermore, the disks 624 may be a CD-ROM drive, a CD-R drive, a CD-RW drive, a DVD ROM, and so on. The memory 614 can store a process 602 and/or a data 604, for example. The disk 624 and/or the memory 614 can store an operating system that controls and allocates resources of the computer 606.

The computer 606 may interact with input/output (I/O) devices via the I/O interfaces 616 and the I/O ports 618. The I/O devices may be, for example, a keyboard, a microphone, a pointing and selection device, cameras, video cards, displays, the disks 624, the network devices 620, and so on. The I/O ports 618 may include, for example, serial ports, parallel ports, and USB ports.

The computer 606 can operate in a network environment and thus may be connected to the network devices 620 via the I/O interfaces 616, and/or the I/O ports 618. Through the network devices 620, the computer 606 may interact with a network. Through the network, the computer 606 may be logically connected to remote computers (e.g., the computer 606 may reside within a distributed computing environment to which clients may connect). Networks with which the computer 606 may interact include, but are not limited to, a local area network (LAN), a new area network (WAN), and other networks.

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “Operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive uϵo.

What is claimed is:

1. A non-transitory computer-readable medium storing computer-executable instructions that when executed by a processor of a computer causes the processor to:
receive and parse an electronic order to identify at least an item and an item destination;
identify a set of sourcing locations capable of sourcing the item for the electronic order;
apply a set of weighted criteria to each sourcing location of the set of sourcing locations, wherein a sourcing location is assigned by the set of weighted criteria a set of weighted cost values representing costs associated with processing the item from the sourcing location to the item destination;
generate ranks for each sourcing location of the set of sourcing locations, wherein the sourcing location is assigned a rank based on a combination of the set of weighed cost values assigned to the sourcing location;
generate a set of control instructions within a data structure that (i) identify the item from the electronic order and (ii) identify a target sourcing location from the set of sourcing locations having a target rank exceeding a threshold; and
responsive to receiving an order assignment inquiry from the target sourcing location, send the data structure to a remote computer, associated with the target sourcing location, for executing the set of control instructions to cause the remote computer to initiate a transfer of the item from the target sourcing location to the item destination.

2. The non-transitory computer-readable medium of claim 1, wherein the instructions for applying the set of weighted criteria to each sourcing location include instructions to cause the processor to at least one of:
assign a first weighted cost value to the sourcing location based upon a first weighted criteria corresponding to a labor cost to process the item from the sourcing location;
assign a second weighted cost value to the sourcing location based upon a second weighted criteria corresponding to a gross margin for selling the item through the sourcing location;
assign a third weighted cost value to the sourcing location based upon a third weighted criteria corresponding to a proximity of the sourcing location to the item destination;
assign a fourth weighted cost value to the sourcing location based upon a fourth weighted criteria corresponding to an on-hand quantity of the item at the sourcing location; or
assign a fifth weighted cost value to the sourcing location based upon a fifth weighted criteria corresponding to a sales velocity of how quickly the item is sold by the sourcing location.

3. The non-transitory computer-readable medium of claim 2, wherein the instructions cause the processor to:
specify the fifth weighted cost value for the fifth weighted criteria based upon a preference for either smaller sales velocity or larger sales velocity.

4. The non-transitory computer-readable medium of claim 1, wherein the instructions for generating the ranks for each sourcing location of the set of sourcing locations include instructions to cause the processor to:
assign the rank to the sourcing location based upon a net profit metric determined based upon the first weighted cost value of the labor cost and the second weighted cost value of the gross margin.

5. The non-transitory computer-readable medium of claim 1, wherein the instructions cause the processor to:
filter the set of sourcing locations based upon whether sourcing locations support an order type of the electronic order, wherein the order type is either a delivery order type, a pickup order type, or a ship for pickup order type.

6. The non-transitory computer-readable medium of claim 1, wherein the instructions cause the processor to:
responsive to a split order setting being enabled and a second item being identified from the electronic order, identify the set of sourcing locations as comprising a first set of sourcing locations for the item and a second set of sourcing locations for the second item.

7. The non-transitory computer-readable medium of claim 1, wherein the instructions cause the processor to:
responsive to a split line setting being enabled and the order requesting a quantity of the item that is greater than one, identify the set of sourcing locations as comprising sourcing locations that can partially fulfill the quantity of the item.

8. The non-transitory computer-readable medium of claim 1, wherein the instructions cause the processor to:
responsive to a backorder setting being enabled and the set of sourcing locations comprising no sourcing locations capable of satisfying the electronic order with in-stock inventory, identify the set of sourcing locations as comprising sourcing locations having the item on backorder.

9. The non-transitory computer-readable medium of claim 1, wherein the instructions for identifying the set of sourcing locations include instructions to cause the processor to:
identify the set of sourcing locations as comprising sourcing locations that are designated as primary sourcing locations for the item destination based upon the primary sourcing locations being within a primary zone specified for a location of the item destination; and
responsive to the set of sourcing locations comprising no primary locations capable of satisfying the electronic order, identify the set of sourcing locations that are designated as secondary sourcing locations for the item destination.

10. The non-transitory computer-readable medium of claim 1, wherein the instructions cause the processor to:
filter the set of sourcing locations based upon an order limit criteria limiting a number of orders that sourcing locations are allowed to fulfill within a timespan.

11. A computing system, comprising:
a processor connect to memory;
a shipment controller stored on a non-transitory computer readable medium and configured with instructions that when executed by the processor cause the processor to:
receive and parse an electronic order to identify at least an item and an item destination;
identify a set of sourcing locations capable of sourcing the item for the electronic order;
apply a set of weighted criteria to each sourcing location of the set of sourcing locations, wherein a sourcing location is assigned by the set of weighted criteria a set of weighted cost values representing costs associated with processing the item from the sourcing location to the item destination;
generate ranks for each sourcing location of the set of sourcing locations, wherein the sourcing location is assigned a rank based on a combination of the set of weighed cost values assigned to the sourcing location;
generate a set of control instructions within a data structure that (i) identify the item from the electronic order and (ii) identify a target sourcing location from the set of sourcing locations having a target rank exceeding a threshold; and
responsive to receiving an order assignment inquiry from the target sourcing location, send the data structure to a remote computer, associated with the target sourcing location, for executing the set of control instructions to cause the remote computer to initiate a transfer of the item from the target sourcing location to the item destination.

12. The computing system of claim 11, wherein the instructions for identifying the set of sourcing locations include instructions to cause the processor to:
send a request, to a second remote computer associated with a second sourcing location, for real-time inventory information of the second sourcing location; and
determine whether to include the second sourcing location within the set of sourcing locations based upon the real-time inventory indicating that the item is available at the second sourcing location.

13. The computing system of claim 11, wherein the instructions cause the processor to:
responsive to a split order setting being enabled and a second item being identified from the electronic order, identify the set of sourcing locations as comprising a first set of sourcing locations for the item and a second set of sourcing locations for the second item.

14. The computing system of claim 11, wherein the instructions cause the processor to:
responsive to the electronic order requesting multiple items and the electronic order being split a threshold number of times between sourcing locations, marking the electronic order as unfulfillable.

15. The computing system of claim 11, wherein the instructions for applying the set of weighted criteria to each sourcing location include instructions to cause the processor to at least one of:
assign a first weighted cost value to the sourcing location based upon a first weighted criteria corresponding to a labor cost to process the item from the sourcing location;
assign a second weighted cost value to the sourcing location based upon a second weighted criteria corresponding to a gross margin for selling the item through the sourcing location;
assign a third weighted cost value to the sourcing location based upon a third weighted criteria corresponding to a proximity of the sourcing location to the item destination;
assign a fourth weighted cost value to the sourcing location based upon a fourth weighted criteria corresponding to an on-hand quantity of the item at the sourcing location; or
assign a fifth weighted cost value to the sourcing location based upon a fifth weighted criteria corresponding to a sales velocity of how quickly the item is sold by the sourcing location.

16. A computer-implemented method, the computer-implemented method involving a computing device comprising a processor, and the computer-implemented method comprising:
executing, on the processor, instructions that cause the computing device to perform operations that:
receive and parse an electronic order to identify at least an item and an item destination;
identify a set of sourcing locations capable of sourcing the item for the electronic order;
apply a set of weighted criteria to each sourcing location of the set of sourcing locations, wherein a sourcing location is assigned by the set of weighted criteria a set of weighted cost values representing costs associated with processing the item from the sourcing location to the item destination;
generate a set of control instructions within a data structure that (i) identify the item from the electronic order and (ii) identify a target sourcing location from the set of sourcing locations having a target rank exceeding a threshold;
generate a set of control instructions within a data structure that identify the item and a target sourcing location from the set of sourcing locations having a target rank exceeding a threshold; and
responsive to receiving an order assignment inquiry from the target sourcing location, send the data structure to a remote computer, associated with the target sourcing location, for executing the set of control instructions to cause the remote computer to initiate a transfer of the item from the target sourcing location to the item destination.

17. The computer-implemented method of claim 16, wherein the instructions cause the computing device to:
filter the set of sourcing locations based upon a reserve stock criteria that filters sourcing locations with amounts of the item that do not exceed a reserve stock threshold.

18. The computer-implemented method of claim 16, wherein the instructions cause the computing device to:
filter the set of sourcing locations based upon an origination location criteria specifying that if the sourcing location is an originating location of the electronic order, then the sourcing location is to be removed from the set of sourcing locations.

19. The computer-implemented method of claim 16, wherein the instructions for applying the set of weighted criteria to each sourcing location include instructions to cause the computing device to at least one of:
assign a first weighted cost value to the sourcing location based upon a first weighted criteria corresponding to a labor cost to process the item from the sourcing location;
assign a second weighted cost value to the sourcing location based upon a second weighted criteria corresponding to a gross margin for selling the item through the sourcing location;
assign a third weighted cost value to the sourcing location based upon a third weighted criteria corresponding to a proximity of the sourcing location to the item destination;
assign a fourth weighted cost value to the sourcing location based upon a fourth weighted criteria corresponding to an on-hand quantity of the item at the sourcing location; or
assign a fifth weighted cost value to the sourcing location based upon a fifth weighted criteria corresponding to a sales velocity of how quickly the item is sold by the sourcing location.

20. The computer-implemented method of claim 16, wherein the instructions cause the computing device to:
filter the set of sourcing locations to remove sourcing locations that are beyond a threshold distance of a location of a customer of the electronic order.
